(19) United States
(12) Patent Application Publication
(10) Pub. No.: US 2002/0126623 A1
(43) Pub. Date: Sep. 12, 2002

(54) Method for decentralized transmission and distribution of user data between subscribers in a telecommunications network

(76) Inventor: Robert Kiendl, Munich (DE)

Correspondence Address: George W. Dishong, DISHONG LAW OFFICES, 40 Bryant Road, Jaffrey, NH, 03452, US

(21) Appl. No.: 09/799,762

(22) Filed: Mar. 6, 2001

(51) Int. Cl. H04J 1/16; H04J 3/14; H04L 12/26; H04L 12/56; H04Q 11/00

(52) U.S. Cl. 370/238; 370/386; 370/411

(57) ABSTRACT

In the communication method according to the invention, the user data are passed on iteratively between subscribers (A, B), with the user data communication being the stimulus for second-order communication (explorer communication), by means of which network structure data are determined and/or refreshed. The explorer data are transmitted iteratively on the same or on a different communications infrastructure as the user data, with the data being passed on in unchanged or processed form during transmission. The explorer data contain explicit requests relating to network structure data and can thus actively initiate the process of obtaining network structure data. Suitable communication paths (a, b, c) for passing on user data iteratively are calculated on the basis of the network structure data which are already available locally, in particular on the basis of previous communications processes, or which are obtained by requests. The method according to the invention can be used in telecommunications networks which are structured and/or in which capacity is limited.

The invention relates to a method for decentralized transmission and distribution of user data between subscribers in a self-administering telecommunications network which has a large number of mobile and/or stationary subscribers.

In particular, the invention relates to a method for decentralized optimization of information transport in telecommunications networks where capacity is limited, and for carrying out telecommunications management functions dynamically and in a decentralized manner, such as subscriber list administration, setting up connections, routing and correction mechanisms.

Telecommunications networks which have a large number of mobile and/or stationary subscribers are nowadays normally provided with control centres via which the desired communications connections are switched and passed. In modern mobile radio systems with a cellular network structure, each radio cell has an associated so-called base station which is in the form of a transmitting and receiving device and via which the message connections to the subscribers located within this radio cell are handled. However, the technical complexity in cellular systems for a large number of subscribers is enormous, since the number of radio cells is governed mainly by the amount of voice traffic which can be expected in a defined area and which is very high in particular in high population density regions, and the maximum possible frequency repetition factor. Another disadvantage with such central telecommunications networks is the fixed installation of the system facilities, which results in high procurement costs and insufficiently good flexibility, particularly in systems for mobile subscribers.

Various methods for transmission of data have been proposed and are known in the context of traffic management systems for vehicles, and these will be described in the following text.

A method for reducing the amount of data to be transmitted to a central computer from the vehicles in a sample vehicle fleet is known from EP 0 715 286 A1. In this case, before sample data are passed on to the central computer, vehicle data are averaged locally in a substitute group of vehicles which are within radio range of one another, in order then to be transmitted from one selected vehicle to the central computer. However, this is not an information network organized globally in a decentralized manner, but is merely single-stage preprocessing with regard to the transfer of data to a central computer, which then satisfies out all the globally relevant processing functionalities.

A method for signalling local traffic problems is described in PCT/EP 98/07283. In this case, the information processing of the traffic-relevant data is carried out in a decentralized form, by forming explicit vehicle groups and supergroups in vehicles which are connected to one another locally by vehicle-vehicle communication. A group spokesman is in this case stated to be advantageous for consistency of group administration.

German Patent Application 19903909.7 proposes a decentralized, self-organizing traffic management system, which is likewise based on decentralized vehicle-vehicle communication in order to form a communications network. In this case, the problem of efficient long-range information links between vehicles to form a functional network is solved by a request and caching mechanism. The communication and processing volume is in this case optimized by requirement-induced adaptive formation of source, information and transport hierarchies. This is used for efficient bundling of source data, information structures and transmission processes. In this case, the hierarchies are not necessarily created by forming explicit discrete groups, which require a selected group spokesman, but are preferably formed implicitly and continuously by information potentials, for example by a criterion relating to the completeness of the information, thus resulting in a high level of stability and redundancy. Apart from the aspect of induced bundling, the already mentioned request and caching mechanism ensures the necessary global feedback in order to allow advanced forms of distributed information processing, such as distributed simulative prediction, long-term integration, the formation of statistics etc., to be carried out on the network as well, which would otherwise require a central processing facility. The method proposed here for obtaining relevant traffic information and for dynamic route optimization may also include the use of so-called pseudo vehicles which may have only a communication purpose, and transmission of “third-party data”, which is not necessarily traffic-related, but which, in conjunction with traffic management, allows the implementation of a general, decentralized mobile radio telecommunications network, including decentralized telecommunications management.

In the method according to German Patent Application 19903909.7, a dynamic, iterative telecommunications network is accordingly set up via the vehicle scenario in order, in the end, to achieve optimum control of the vehicles. Efficient information transport is required for this purpose, in order to create good long-range networking. There, this problem is solved in that the iterative radio communication attempts to bridge geometric paths which are as short as possible. For example, an iteratively transmitted request data packet travels on an “air line” which is geometrically as direct as possible into the destination region or regions, provided the vehicle location situation allows this. This procedure is sufficient and worthwhile provided the communication paths themselves are not overloaded and need not be selected from communication resources which are structured in an excessively discontinuous manner.

Against the background of the last-described method for obtaining relevant traffic information and for dynamic route optimization in which the target objects to be managed are vehicles and pseudo vehicles, the object of the invention is to optimize the routes for information transport between subscribers, in a decentralized form, in a limited-capacity and/or structured telecommunications network and, in the process, to optimize the use of the transmission channels.

This object is achieved according to the invention in the case of a method for decentralized transmission and distribution of user data between subscribers in a self-administering telecommunications network or subnetwork which has a large number of mobile and/or stationary subscribers, in that the user data are passed on iteratively between the subscribers, in that the user data communication is the stimulus for second-order communication (explorer communication), by means of which the network structure data are determined and/or refreshed, in that the explorer data are transmitted iteratively on the same or on a different communications infrastructure as the user data, with the data being passed on in unchanged or preprocessed form during transmission, in that the explorer data contain explicit requests relating to the network structure data and can thus actively initiate the process of obtaining network structure data, and in that suitable communication paths for passing on user data iteratively are calculated on the basis of the network structure data which are already available locally, in particular on the basis of previous communications processes, or which are obtained by requests. If the relevant network structure data require position information from subscribers/transmission units, this can be supplied, for example, by GPS (global positioning system). Since, as a rule, there is no need for exact position information for routing, addressing and other services, it is also feasible for less accurate position information to be obtained from the interaction of topological neighbourhood information relating to subscribers, reception field strength, numbers of routes and the like.

The method according to the invention thus relates to the provision of an optimum path through a limited and/or structured telecommunications network for data packets to be transmitted or for a data stream to be transmitted, in an analogous manner to the optimum self-organizing navigation of vehicles in a road traffic network. If the method according to the invention is used within the method proposed in German Patent Application 19903909.7 in order to obtain relevant traffic information and for dynamic route optimization, with vehicles/mobile telephones being used as communicators, this would thus result in a self-organizing, second-order navigation system, with vehicle movements being optimized by first-order communication, and the first-order communication being optimized by second-order communication.

In this context, it should be noted that one worthwhile application is also feasible, in which the method according to the invention is in turn applied to itself, that is to say, in general, this relates to a self-organizing, n-th order movement and communication optimization process. Such applications should also be included in the scope of the invention.

In the self-organizing communication optimization method which operates according to the invention, the information transport looks after itself.

Expedient and advantageous developments of the method according to the invention are specified in the dependent claims.

The invention together with developments and applications of it will be explained in the following text with reference to drawings, in which:

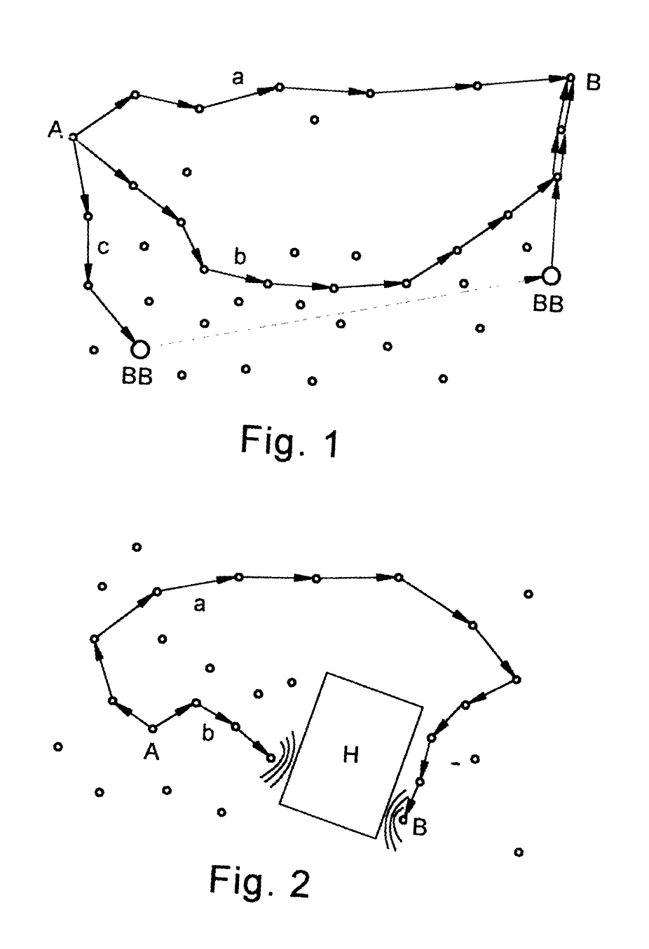

FIG. 1 uses a schematic illustration of a telecommunications network to illustrate possible communication routes between two end points,

FIG. 2 likewise uses a schematic illustration to show radio paths in a telecommunications network which has obstructions or gaps,

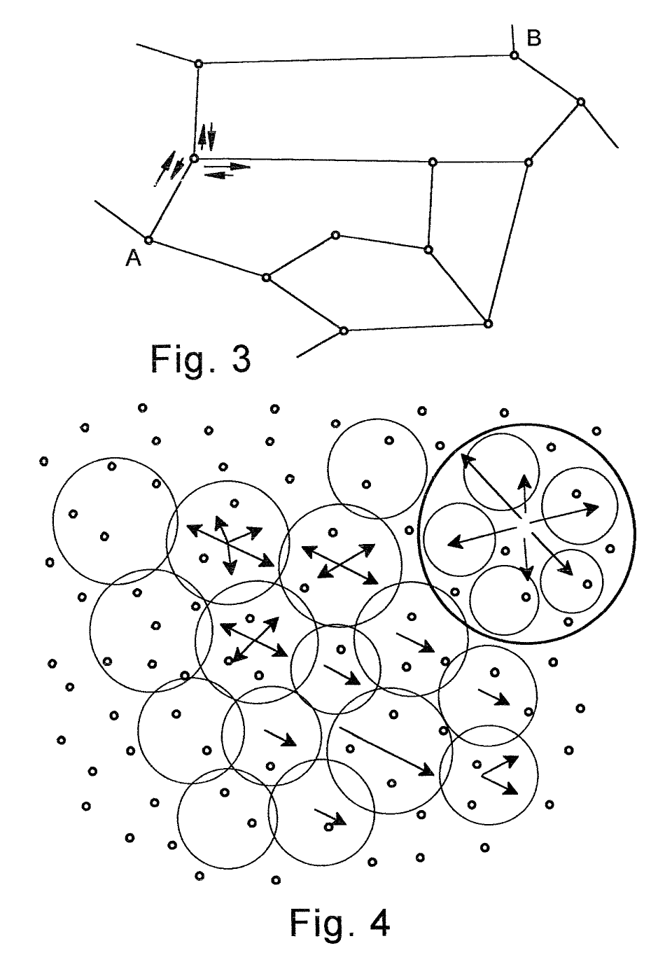

FIG. 3 shows an example of a decentrally organized (fixed) network structure in line form, and

FIG. 4 shows an example of a continuous chart structure with communication moment fields.

In a decentralized mobile radio telecommunications network, there are normally limited communication resources between the subscribers formed by mobile telephones or pseudo vehicles. In a scenario for iterative decentralized radio communication, FIG. 1 shows possible communication routes between two end points A and B in a telecommunications network with a large number of subscribers, who are illustrated in the form of small circles. A first connecting route a runs via a route which is optimum when everything is static. If a very large number of communication links are set up at the same time in the telecommunications network, the connecting route a across the thinned-out area of subscribers may, however, become a bottleneck. In this situation, the connecting route b would be more suitable, or else even the longer connecting route c, if a backbone network with advantageously located stations BB has an appropriate amount of free capacity. Furthermore, the problem is normally to explore any links whatsoever from one subscriber to another subscriber in a decentralized manner and to find an optimum load distribution for the telecommunications network, in a decentralized manner.

In the case of pure dynamic connecting route optimization with a sufficient number of vehicle subscribers, there are always geometrically suitably positioned vehicle subscribers for passing on data to a specific destination region in a highly structured telecommunications network in a self-organizing traffic navigation system corresponding to that according to German Patent Application 19903909.7. However, if there are any relatively major obstructions or gaps in a direct iterative radio path, then a direct communication attempt between the two subscribers A and B, as in the case of the route b in FIG. 2, ends in a blind alley at a radio obstruction H from which simple routing, on a geometric basis, may no longer be feasible and, at least temporarily, no link can be set up since at least one complex search process, whose full complexity is precipitated in the volume of communication, is extremely inefficient and slow. The method according to the invention has no problems in finding the connecting route a between the subscribers A and B which, although it represents a circuitous path, is capable of providing communication, however.

Decentralized, dynamic distribution management may make sense even for connecting networks which are one-dimensionally substructured, for example in the case of cable-structured communication in fixed networks, directional radio links, Internet or the like. In the present-day Internet and in telecommunications routers, the routing of data packets functions on the basis of routing tables which are calculated in advance. When a data packet arrives at a router on a feeder line, the destination address of the data packet is read by the router, which then uses a routing table to decide the onward line on which this data packet will be transported further in the direction of the destination. In this case, the data packets may also be distributed randomly on alternative lines, with the weighting values being calculated in advance. It is also possible, for example in the event of line defects, to remove routing entries automatically from the tables. However, according to the prior art, the routing tables are produced on the basis of non-automatic, manual considerations or global, central calculations. No methods are yet known for fully automatic and dynamic, decentralized production of the routing tables.

The method according to the invention can be used in an advantageous manner to carry out the utilization optimization of such a one-dimensionally substructured network fully automatically, dynamically and in a decentralized manner. It is likewise possible to carry out communication management functions in a decentralized manner in this way, without having to refer to explicit, central lists. In the present-day Internet, for example, name/IP (Internet Protocol)—address allocation—requests are used to find computers and, in the end, are always broken down to so-called statically placed root name servers, with all the information which is stored in distributed form being root-server cache data. The IP addresses are linked to network segments, and thus to the location, on the basis of the static condition of the routing. In consequence, dynamic changes to the structure, for example bypassing a “named” computer, are very difficult and are always associated with manual configuration actions. In contrast, the method according to the invention advantageously allows management functions to be carried out naturally in a decentralized manner and dynamically, without any central link being required.

In the traffic management method proposed in German Patent Application 19903909.7, the functionality of the dynamic vehicle route optimization comprises an iterative interaction between obtaining information and a short-route search, based on this, in an “individual road map” on the basis of the change in the level of knowledge, information being obtained once again as a result of this, and so on. In the method according to the invention, communication in a telecommunications network is optimized using a comparable interaction process. The communication paths or moment fields with path quality weightings/moment field strengths and other network structure data are listed in individual charts or lists of subscribers. When data packets are passed on iteratively on the basis of a short-route search in such a chart or such a list, the optimum routing is predetermined and recommended. At the same time, second-order communication (explorer communication) is carried out, which ensures adaptive, requirement-driven generation and updating of the charts and lists. “Explorer” requests are sent for the further route segments/moment area details which are provisionally regarded as being optimum. These are routed on the telecommunications network on the basis of the existing individual charts and lists. In the worst case, such “explorer” requests would be passed on into the destination regions. The subscribers located there are familiar with the local utilization situation, connection quality and other transmission features by virtue of communication history data. A response to the “explorer” request is produced on the basis of decentralized adjustment of the selection of a suitable route (delay routing). The response is passed back. On being passed back, the responses from the transmitting subscribers and from all those subscribers who become aware of this are cache-stored. If other “explorer” requests now arrive from other subscribers and data currency in the cache memory is sufficient to respond to the “explorer” requests, there is no need to repeat the “explorer” request any more, and it can be answered directly from the cache memory. This mechanism acts in a self-stabilizing manner since a large number of identical “explorer” requests occur when the amount of communication traffic is high, and these then have to run into the destination region only very rarely. If memory space is short, a subscriber can in each case remove obsolescent data from the cache memory.

The requests may include a data-currency requirement in encoded form, which results from a weighting estimate relating in particular to frequent bottlenecks (potential data bottlenecks), the bandwidth of route sections and the distance from the requesting location.

Free computation time and transmission capacity can be used to combine the contents of the cache data (data compression). Such integration is very worthwhile, for example, to organize chart and list data in hierarchical form. A combination to form aggregated subnetwork statements or moment fields with relatively coarse resolution is carried out instead of fully resolved route segments between individual communicators.

It should be stressed that, in terms of volume, the second-order communication in general represents less than the first-order communication. The dynamic changes in the network structure take place on a considerably slower time scale than first-order communication processes. In consequence, the second-order communication processes, that is to say “explorer” requests, responses (answers) and broadcasts, which are intended to reflect the network structure in the individual charts and lists, occur comparatively rarely. The aim of the invention, which the invention also achieves, is to use explorer communication representing a proportion of only a few per cent of the overall communication rate to obtain utilization optimization and a user management function.

In the method according to the invention, the second-order communication and the first-order communication take place on the same telecommunications network. Second-order dispatches can in some cases also be packed in first-order dispatches. For example, when transmitting user data, network structure data can always be packed in the same dispatches as well.

FIG. 3 shows a simple example of a line-structured (fixed) network organized in a decentralized manner. Each of the subscribers and/or routing locations, which are each symbolized by a small circle, are located at routing nodes in this mobile radio network and of which two have been picked out and denoted by A and B, has a chart of this network whose resolution is more or less coarse. The chart may also be in list form. The chart may, for example, be location-related, or may alternatively contain only topological neighbourhood information. The local links are shown in the chart, which lists the paths on which there are local links. The resolution of the chart is advantageously controlled adaptively. The arrows illustrated at one of the routing nodes in FIG. 3 symbolize communication path quality weightings.

The transmission field strength of the transmission units of mobile radio subscribers is set or regulated in an advantageous manner in order to control the number/maximum number of locally accessible subscribers.

The method according to the invention allows advantageous telecommunications management functions to be connected.

Information about local utilization situations and connection situations, addressing information and other transmission-relevant variables, in particular data bottleneck predictions, can be stored within source groups, and maintained there (persistence).

Source groups for so-called home zones can advantageously be formed for addressing administration on the entire telecommunications network, with each subscriber himself determining, over the course of time, one or more home zones in which he is often located. This means that the hit probability for the respective subscriber is particularly high there. When a subscriber is away from his home zone, he broadcasts his approximate location area to his respective home zone or his home zones. Over the course of time, the information about the home zones of the subscribers is distributed very quickly throughout the entire telecommunications network. Since this information is largely constant, there is scarcely any need for updating. Thus, subscriber address requests are at least always very quickly redirected to the home zones in which the approximate present position of the relevant subscriber is then known. This information is then used to trace and accurately determine the position of a subscriber, and a specific area broadcast sequence is transmitted. When a subscriber changes or gives up a home zone, the information is expediently removed slowly from the database, with cross-references to any new home zone.

In the extreme initial state, which scarcely ever occurs in practice, a subscriber would still be virtually unknown in the telecommunications network. In a case such as this, the subscriber's computer transmits only an elementary broadcast to a very small environment. An initial request to another computer would be executed as a breadth search in the form of an area broadcast sequence over a large proportion of the telecommunications network, but this is improbable. The subscriber will probably enter a home zone after a very short initialization phase, and leave a trail with backward-references through the network.

If memory space is short, a subscriber can in each case remove obsolescent data from his cache memory and, if it is known that adjacent subscribers are also storing the information, it can be assumed with a probability of less than 100% that the data are stored in the cache memory. Backbone subscribers, which contain a greater memory capacity, may also be scattered around in the telecommunications network. In any case, with the comparatively small amounts of information involved and the large memories that are now available, shortness of memory space is in any case not really a problem now.

Since a telecommunications network is never permanently 100% utilized, a telecommunications network which operates in a decentralized manner is also able to use free local transmission capacity at any time in order to pass group information, for example about new subscribers, actively via the network. One important finding is that the highly redundant, apparently ineffective communication form of decentralized network management relates only to a small number of basic services, such as setting up home zones and the initial spreading of address information, and that a highly objective procedure comes into play again very quickly. The resources available for the basic services are always far more than adequate since free resources can be exploited for this purpose because no telecommunications network is ever continuously 100% loaded.

A limited number of entries are stored in each routing node. More powerful routing nodes with more memory space, that is to say nodes which can store a greater number of entries in cache, can be distributed randomly in the network, or can be concealed behind “real” backbone networks. However, strictly speaking, such nodes have nothing to do with central administration. Such nodes can be installed and removed at locations as required, and their particular additional potentials are exploited fully automatically and dynamically.

Error back-propagation is expediently used when an incorrect routing occurs. Incorrect chart and list entries, and/or chart and list entries which are no longer up-to-date, can thus quickly be removed from the database.

The following text describes the term “chart”, since this appears to be necessary in order to comply with the major forms of application to which the method according to the invention relates. In principle, appropriately designed lists can also be provided, instead of charts, as information sources at the subscribers or in memories external to the network.

In this context, an example with decentralized mobile radio communication will be described with reference to FIG. 4. FIG. 4 shows a situation illustrating how a communication moment field is applied to a scene with a large number of decentralized mobile radio communication subscribers, who are represented by small circles. Each relatively large circle in the chart symbolizes, for example, a continued connection quality unit which, averaged over the explicit on-site situation of the individual discrete subscribers, represents the connection situation of the zone unit for transmitting data packets beyond itself. Long arrows to the right mean, for example, a large amount of free transmission capacity. The large circle shown in bold on the right-hand side of FIG. 4 shows a higher hierarchy level/coarsening of moment cells. Depending on the size, a super cell is formed from a number of cells by averaging or, in general, by aggregation, that is to say the chart data are compressed.

A combination of information and a short-route algorithm can thus advantageously be provided on this chart structure.

The dimensions of moment units may, for example, be: position, angle, total transmission capacity, average transmission capacity being used, subscriber density, mean local transmission radius, Fourier time integrals of previous variables (detection of periodic fluctuations throughout the day) and local gradients in the cell.

At this point, it should be noted that applications with three-dimensional chart areas should also be included in the method according to the invention. However, in the first stage, conventional, one-dimensionally understructured charts would, for example, as in the case of traffic management, be sufficient on fixed networks.

1. Method for decentralized transmission and distribution of user data between subscribers in a self-administering telecommunications network or subnetwork which has a large number of mobile and/or stationary subscribers,
characterized
in that the user data are passed on iteratively between the subscribers,
in that the user data communication is the stimulus for second-order communication (explorer communication), by means of which network structure data are determined and/or refreshed,
in that the explorer data are transmitted iteratively on the same or on a different communications infrastructure as the user data, with the data being passed on in unchanged or preprocessed form during transmission,
in that the explorer data contain explicit requests relating to network structure data and can thus actively initiate the process of obtaining network structure data, and
in that suitable communication paths for passing on user data iteratively are calculated on the basis of the network structure data which are already available locally, in particular on the basis of previous communications processes, or which are obtained by requests.

2. Method according to claim 1,
characterized
in that network structure data such as subscriber densities, path quality weightings, locations and the like are maintained in charts or lists.

3. Method according to claim 2,
characterized
in that the charts or lists are in the form of distributed subscriber charts or lists but, at least partially, can also be maintained in memories, for example central memories, which are external to the telecommunications network.

4. Method according to claim 2 or 3,
characterized
in that locations, connections and entries in the charts or lists are represented discretely and/or continuously.

5. Method according to one of claims 2 to 4,
characterized
in that the locations and regions of the charts or lists are in the form of geometric areas and/or topological areas or graphs in which only neighbourhoods are defined.

6. Method according to one of claims 2 to 5,
characterized
in that the charts and lists have hierarchical structures, in such a way that unimportant regions, in particular regions a long distance away, are represented using a compressed, coarser resolution.

7. Method according to one of the preceding claims,
characterized
in that, when network structure data are compressed from non-directional scalars, higher moments of these scalars are also calculated, as a result of which directional variables, such as moment-related path quality weightings, can be obtained.

8. Method according to one of the preceding claims,
characterized
in that suitable communication paths for passing on user data are determined by iterative interaction from requests to path elements which are provisionally regarded as being optimum and recalculations of optimum paths on the basis of new and/or corrected data.

9. Method according to one of the preceding claims,
characterized
in that explorer data for the subscribers located on the transmission path are stored in cache, and
in that, when explorer data requests relate to subscribers with suitable cache data, and if the data-currency requirements are met, the requests are satisfied directly from the cache memories.

10. Method according to one of claims 2 to 9,
characterized
in that possible chart and list contents are, in particular, subscriber densities, utilization level, path qualities, n-th moments, locations and telephone directories.

11. Method according to one of the preceding claims,
characterized by
decentralized adjustment of the selection of suitable routing of the user data (delay routing).

12. Method according to one of the preceding claims,
characterized by
inclusion of backbone paths and/or backbone networks in the telecommunications network, and/or coupling of the telecommunications network to one or more other telecommunications networks.

13. Method according to one of the preceding claims,
characterized
in that, for radio transmission, the transmission field strength of the transmission units of the subscribers is in each case set or regulated in order to control the number/maximum number of locally accessible subscribers.

14. Method according to one of the preceding claims,
characterized
in that information about local utilization situations and connection situations, addressing information and other transmission-relevant variables, in particular data bottleneck predictions, are stored within the source groups, and maintained there (persistence).

15. Method according to claim 14, characterized in that source groups for so-called home zones are formed for addressing administration on the entire telecommunications network, with each subscriber himself determining, over the course of time, one or more home zones in which he is often located, which means that the hit probability of the respective subscriber is particularly high there, and
in that, when a subscriber is away from his home zone, or is away from one of his home zones, he transmits his approximate location area to his respective home zone or his home zones as information, so that subscriber address requests are at least always very quickly redirected to the home zones in which the approximate present position of the relevant subscriber is then known, and this information can then be used to trace and accurately determine the position of a subscriber, and a specific area broadcast sequence can be transmitted.

16. Method according to one of the preceding claims,
characterized
in that the explorer data requests include a data-currency requirement in encoded form, which results from a weighting estimate which relates in particular to frequent bottlenecks (potential data bottlenecks), the bandwidth of route sections and the distance from the request location.

17. Method according to one of the preceding claims,
characterized
in that free computation time and transmission capacity are used to combine cache data.

18. Method according to one of the preceding claims,
characterized
in that free computation time and transmission capacity are used to organize the chart data in hierarchical form, with a combination to form aggregated subnetwork statements/moment fields with relatively coarse resolution being carried out instead of fully resolved route segments between individual communicators.

19. Method according to one of the preceding claims,
characterized by
the method being applied to itself, thus, in general, resulting in a self-organizing, n-th order movement/communication optimization process.
